(19) United States
(12) Patent Application Publication
(10) Pub. No.: US 2014/0298820 A1
(43) Pub. Date: Oct. 9, 2014

(54) GAS TURBINE ENGINE AND METHOD FOR STARTING SAME

(71) Applicant: KAWASAKI JUKOGYO KABUSHIKI KAISHA, Kobe-shi (JP)

(72) Inventors: Yoshihiro YAMASAKI, Kobe-shi (JP); Daisuke UEMURA, Kobe-shi (JP); Soh KUROSAKA, Kobe-shi (JP); Kazuya MATSUO, Kobe-shi (JP)

(73) Assignee: KAWASAKI JUKOGYO KABUSHIKI KAISHA, Kobe-shi (JP)

(21) Appl. No.: 14/307,954

(22) Filed: Jun. 18, 2014

Related U.S. Application Data
(63) Continuation of application No. PCT/JP2012/081815, filed on Dec. 7, 2012.

(30) Foreign Application Priority Data
Dec. 22, 2011 (JP) 2011-280948

(51) Int. Cl. F02C 7/26

(52) U.S. Cl. CPC F02C 7/26
USPC 60/778; 60/786

(57) ABSTRACT

A starting method for a gas turbine engine includes a primary warming step of warming up the gas turbine engine while a constant primary warm-up rotation speed is maintained by an inverter motor and a secondary warming step of warming up the gas turbine engine while a constant secondary warm-up rotation speed is maintained by further increasing the speed of the inverter motor. The primary warming step terminates when an electric power required by the inverter motor attains a predetermined preset electric power value. The preset electric power value is so chosen as to decrease as the intake air temperature is low.

### CROSS REFERENCE TO THE RELATED APPLICATION

This application is a continuation application, under 35 U.S.C §111(a) of international application No. PCT/JP2012/081815, filed Dec. 7, 2012, which claims priority to Japanese patent application No. 2011-280948, filed Dec. 22, 2011, the entire disclosure of which is herein incorporated by reference as a part of this application.

### BACKGROUND OF THE INVENTION

1. Field of the Invention

The present invention relates to a gas turbine engine utilizing an electrically operated motor and a method of starting the same.

2. Description of Related Art

As a starting method for an electric power generator utilizing a gas turbine engine, the system has been well known in which after a warm-up has been conducted by maintaining the gas turbine engine at a constant rotation speed or a constant number of revolutions with an induction generator used as a driving motor controlled by a power converter, a main combustor is ignited. In this respect, see, for example, the patent document 1 listed below.

### PRIOR ART LITERATURE

Patent Document 1: JP Laid-open Patent Publication No. 2011-196355

In the case of the starting method disclosed in the patent document 1 listed above, as the rotation speed to be maintained at a constant value is increased, the intake air flow rate is increased accompanied by reduction of the length of time during which the warm-up takes place and, on the other hand, the consumption of the electric power used increases in a fashion expressed by the cubic function. As a result, the electric power consumption of the motor attains the maximum value at the beginning of the start and, in accord with the electric power consumption of the motor at the beginning of the start, the need has been recognized to increase the capacity of the power converter and/or the induction generator.

### SUMMARY OF THE INVENTION

The present invention has been devised in view of the foregoing and is intended to provide a gas turbine engine of a type, in which the peak of the electric power consumed during the start is suppressed to allow the gas turbine engine to be started with the power converter and/or the induction generator of a low capacity.

In order to accomplish the foregoing object, the present invention provides a method of starting a gas turbine engine including a compressor to compress an intake air to thereby generate a compressed gas, a combustor to burn the compressed gas to thereby generate a high temperature, high pressure combustion gas, a turbine driven by the combustion gas, and a starter device in the form of a rotating machine which concurrently serves as an electric power generator driven by the turbine, the starter device including an inverter motor. The gas turbine engine starting method of the present invention includes a primary warming step of warming up the gas turbine engine while a constant primary warm-up rotation speed is maintained by the inverter motor, and a secondary warming step of warming up the gas turbine engine while a constant secondary warm-up rotation speed is maintained by further increasing the speed of the inverter motor.

According to the conventional gas turbine engine, the speed has been boosted in a matter of minutes from the starting to the timing at which a predetermined warm-up rotation speed corresponding to the secondary warm-up rotation speed is attained. For this reason, the electric power, which the rotating machine requires, (hereinafter referred to as “required motor electric power”) attains a high peak value immediately after the beginning of the starting and the capacity of the power converter and the induction generator that is determined by the peak value need be increased. However, according to this construction, since the warm-up is implemented in two stages, as compared with the peak value of the conventional required motor electric power, the maximum value of the required motor electric power can be reduced to a low value and, as a result, the capacity of the inverter motor can be minimized.

In a preferred embodiment of the present invention, the primary warming step preferably terminates when an electric power required by the inverter motor attains a preset electric power value, which is predetermined in correspondence with an intake air temperature. The preset electric power value is so set as to be low, for example, as the intake air temperature is low.

Since the suction flow rate in the gas turbine engine changes with the intake air temperature, the compression driving power changes with the intake air temperature. As the lower the intake air temperature, the intake air flow rate increases accompanied by an increase of the compression driving power even for a given rotation speed. In other words, the electric power consumption of the motor changes with the intake air temperature. Accordingly, the power converter and the induction generator of a high capacity, in which the low intake air temperature during the winter is taken into consideration, has hitherto been needed to use. However, according to this construction, since the primary warm-up termination is changed in dependence on the intake air temperature and the preset electric power value is so determined that the maximum value of the required motor electric power does not exceed a predetermined value, it is possible to render the maximum value of the required motor electric power to be constant without being affected by the intake air temperature. As a result, the capacity of the inverter motor can be further reduced.

In another preferred embodiment of the present invention, the gas turbine engine may include a heat exchanger to heat the compressed gas by means of the exhaust gas from the turbine, in which case during the primary warming step and the secondary warming step, the gas turbine engine is warmed up by increasing the temperature of the compressed gas, which is increased by increasing the temperature of the exhaust gas. According to this construction, the gas turbine engine can be effectively warmed up with the utilization of the exhaust gas.

In a further preferred embodiment of the present invention, the gas turbine engine may include a power converter connected with the rotating machine and comprised of an inverter and a converter, in which case the rotating machine is driven as a starter device at the time of starting, and during the primary warming step and the secondary warming step, the primary and secondary warm-up numbers of revolutions are respectively retained after the primary and secondary warm-up numbers of revolutions have been attained. According to this construction, in addition to the capacity of the inverter motor, the capacity of the power converter can have a reduced size.

In a yet preferred embodiment of the present invention, the gas turbine engine referred to above is preferably a lean fuel intake gas turbine engine. Since the lean fuel intake gas turbine engine is not frequently booted, an influence on the system as a whole is minimal even though the length of time required to start is long. The lean fuel is a fuel containing a small quantity of inflammable component such as, for example, a ventilation air methane (VAM) and/or a coal mine methane (CMM) and is of a kind that will not be ignited when being compressed by a compressor.

The present invention in accordance with a different aspect thereof provides a gas turbine engine which includes a compressor to compress an intake air to thereby a compressed gas; a combustor to burn the compressed gas to thereby generate a high temperature, high pressure combustion gas; a turbine driven by the combustion gas; a starter device comprised of a rotating machine concurrently serving as an electric power generator driven by the turbine, the starter device including an inverter motor; and a controller which is capable of performing such a control that a primary warm-up is effected to the gas turbine engine while a constant primary warm-up rotation speed is maintained by the inverter motor and a secondary warm-up is also effected to the gas turbine engine while a constant secondary warm-up rotation speed is maintained by further increasing the speed by means of the inverter motor.

According to the above described construction, since the warm-up is implemented in two stages, as compared with the peak value of the conventional required motor electric power, the maximum value of the required motor electric power can be reduced to a low value and, as a result, the capacity of the inverter motor can be minimized.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic diagram showing a gas turbine engine designed according to a preferred embodiment of the present invention;

FIG. 2 is a characteristic chart showing respective changes in a fuel valve opening, a required motor electric power and rotation speed at the start of the gas turbine engine; and

FIG. 3 is a chart showing the motor electric powers required at the start at different intake air temperatures in the gas turbine engine.

### DESCRIPTION OF PREFERRED EMBODIMENTS

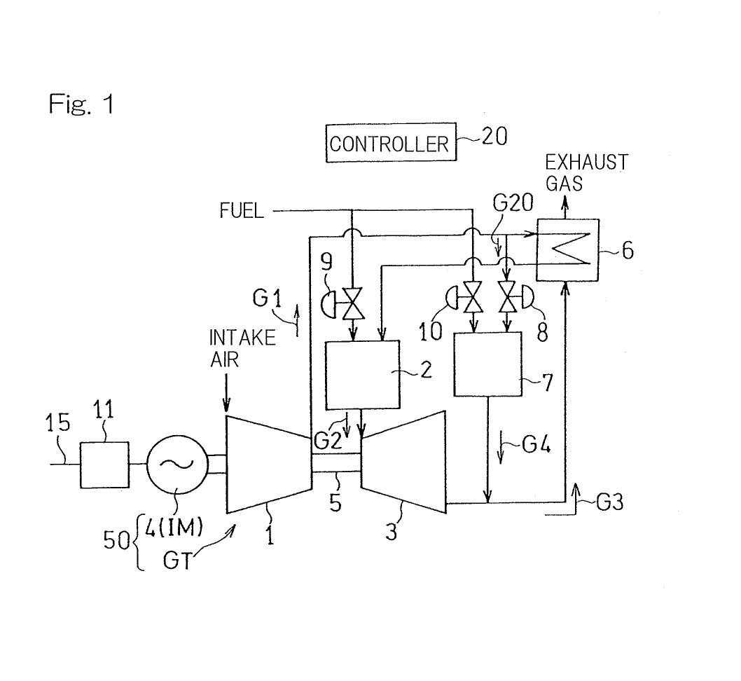

Hereinafter a preferred embodiment of the present invention will be described in detail with particular reference to the accompanying drawings. In particular, FIG. 1 illustrates a schematic structure of a gas turbine engine according to the preferred embodiment of the present invention. The illustrated gas turbine engine GT includes a compressor 1, a main combustor 2 comprised of a catalytic combustor having a catalyst such as, for example, platinum and/or palladium, and a turbine 3. By an output of the gas turbine engine GT, a rotating machine 4 concurrently serving as an electric power generator and a starter device is driven. The rotating machine 4 is connected with a power converter 11 comprised of an inverter and a converter, and the starter device includes an inverter motor IM and the power converter 11.

An intake air such as, for example, air is compressed by the compressor 1 to produce a high pressure compressed gas G1 which is in turn supplied to the main combustor 2. This compressed gas G1 is burned as a result of the catalytic reaction of the catalyst such as, for example, platinum and/or palladium within the main combustor 2 to thereby generate a high temperature, high pressure combustion gas G2, which gas G2 is supplied to the turbine 3 to drive such turbine 3. The turbine 3 is connected with the compressor 1 through a rotary shaft 5 and, accordingly, the compressor 1 is driven by the turbine 3. The rotary shaft 5 connecting between the compressor 1 and the turbine 3 is, for example, a single shaft, and this rotary shaft 5 and the rotating machine 4 are connected together. In this way, an electric power generating device 50 including the gas turbine engine GT and the rotating machine 4 is defined thereby.

The gas turbine engine GT also includes a heat exchanger 6 for heating the compressed gas G1, introduced from the compressor 1 into the main combustor 2, by the action of the exhaust gas G3 from the turbine 3, and an auxiliary combustor 7 in the form of a warming burner for boosting the temperature of the exhaust gas G3 at the time of starting to thereby increase the temperature of the compressed gas G1, then flowing into the main combustor 2, to thereby activate the catalyst. This auxiliary combustor 7 is operable to mix a fuel with an extracted gas G20, which is partially extracted from the compressed gas G1, to burn the latter with flame to thereby generate a warming gas G4, and then to mix the warming gas G4 in the exhaust gas G3 then supplied from the turbine 3 to the heat exchanger 6. The auxiliary combustor 7 is fluid connected with a bleed valve 8 for controlling the amount of the extracted gas G20 supplied to the auxiliary combustor 7. The exhaust gas G3 flowing outwardly from the heat exchanger 6 is, after having been silenced through a silencer (not shown), discharged to the outside. The control of the amount of the extracted gas G20 supplied to the auxiliary combustor 7, which is performed by the bleed valve 8, is carried out in response to an output signal from a controller 20.

The supply of the fuel towards the auxiliary combustor 7 is carried out while the flow rate of the fuel is adjusted by a second fuel control valve 10. On the other hand, the supply of the fuel towards the main combustor 2 is carried out while the flow rate of the fuel is adjusted by a first fuel control valve 9. The flow rate adjustments by those first and second fuel control valves 9 and 10 are carried out by the controller 20.

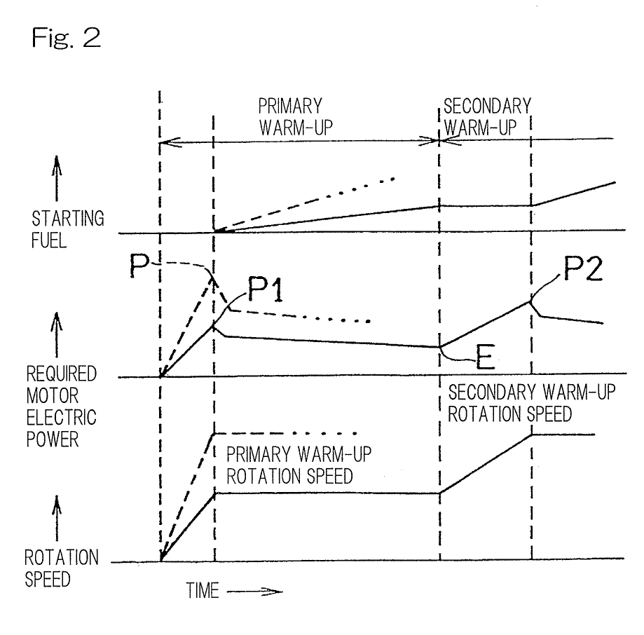

The operation of the gas turbine engine GT of the structure described hereinabove will now be described. Respective controls of the various equipments are all carried out by the controller 20. At the time of starting, without igniting, in response to a command from the controller 20 the power converter 11 makes use of an electric power, supplied from an external electric power system 15, to drive the rotating machine 4 as a starter device. Then, by means of the inverter motor IM, a constant primary warm-up rotation speed is maintained (the primary warming step) as shown in FIG. 2. The primary warm-up rotation speed is a rotation speed departing from a point of resonance of shaft vibration and/or blade vibration and is, for example, 55% of the rated speed. It is to be noted that in FIG. 2, the solid lines represent characteristics of the gas turbine engine of the structure according to the embodiment whereas the broken lines represent characteristics of the conventional gas turbine engine. The required motor electric power abruptly increases from the startup before the primary warm-up rotation speed is attained with a first peak value P1 attained. During a period from the startup to the timing at which the first peak value P1 is attained, the gas turbine engine GT shown in FIG. 1 is driven solely by the inverter motor IM.

Also, after the primary rotation speed has been attained, while the primary warm-up rotation speed is retained by the power converter 11, the bleed valve 8 and the second fuel control valve 10 are opened to ignite the auxiliary combustor 7. Then, with the opening of the second fuel control valve 10 being gradually increased, as shown in FIG. 2, a startup fuel is gradually increased so that the temperature (heat exchanger gas inlet temperature) of the exhaust gas G3 flowing through an exhaust duct connecting between the turbine 3, shown in FIG. 1, and the heat exchanger 6 is increased to boost the temperature of the compressed gas G1 to thereby accomplish the warm-up.

By the primary warm-up, the gas turbine engine GT is gradually warmed up and, as a result of an increase of the turbine inlet temperature the work recovered or done by the turbine 3 is increased. Therefore, the required motor electric power is reduced as shown in FIG. 2.

Termination of the primary warm-up depends on a preset electric power value E predetermined as required for the startup. The preset electric power value E is a value corresponding to the intake air temperature and is specifically so chosen as to be low as the intake air temperature is low to thereby prevent a power required for compression from becoming excessive. The preset electric power value E will hereinafter be described in detail.

The primary warm-up terminates at the moment the required motor electric power attains the predetermined required motor electric power value E, followed by a secondary warm-up (secondary warming step). As the secondary warm-up starts, the engine rotation speed is increased to a secondary warm-up rotation speed. The secondary warm-up rotation speed is also a rotation speed departing from a point of resonance of shaft vibration and/or blade vibration and is, for example, 65% of the rated speed. As shown in FIG. 2, the required motor electric power increases by the time the secondary warm-up rotation speed is attained with a second peak value P2 attained. The second peak value P2 is so set as to be higher than the first peak value P1.

After the secondary warm-up rotation speed has been attained, while the secondary warm-up rotation speed is retained by the power converter 11, the opening of the secondary fuel control valve 10 is further increased to gradually increase a starting fuel, as shown in FIG. 2. By so doing, the firing amount (fuel supply amount) of the auxiliary combustor 7 shown in FIG. 1 is moderately increased so that the temperature of the exhaust gas G3 is increased to complete the warm up. The timing at which the secondary warm-up completes is determined by, for example, a timing device such as, for example, a timer.

Even during the secondary warm-up, the gas turbine engine GT is gradually warmed up and, as a result of an increase of the turbine inlet temperature the work recovered by the turbine 3 is increased. Therefore, the required motor electric power is reduced as shown in FIG. 2. In other words, the required motor electric power is maximal at the second peak value P2 and, from this second peak value P2, the capacity of the power converter 11 and the capacity of the inverter motor IM, both shown in FIG. 1, are determined.

After the secondary warm-up has been completed, while the bleed valve 8 and the second fuel control valve 10 are closed to extinguish the auxiliary combustor 7, the first fuel control valve 9 is opened to ignite the main combustor 2 and, at the same time, the engine rotation speed is increased to increase to the rated rotation speed. The idling run terminates at the time the secondary warm-up is completed and, subsequently, the load mode, that is, the electric power generating mode is transferred at the time the rated rotation speed is attained. During the electric power generating mode, an electric power is supplied from the power converter 11 to the external electric power system 15.

In the construction described above, as shown by the broken lines in FIG. 2, with the conventional gas turbine engine, from the starting the engine speed has been increased in a matter of minutes to the predetermined warm-up rotation speed which corresponds to the secondary warm-up rotation speed. For this reason, the required motor electric power, immediately after the beginning of the start, attains a peak value P which is higher than any of the first and second peak values P1 and P2 afforded in the practice of this embodiment. Therefore, the capacity of the power converter and/or the induction generator, which is determined by this peak value P, need be increased. In contrast thereto, according to the embodiment now under discussion, since the warm-up is carried out in two stages, as compared with the peak value of the conventional required motor electric power, the second peak value P2, which is the maximum value of the required motor electric power, can be suppressed to a low value. As a result, the capacity of the power converter 11 and the capacity of the inverter motor IM can be reduced to low values.

Since the suction flow rate in the gas turbine engine changes with the intake air temperature, the compressor driving power changes with the intake temperature. The lower the intake air temperature, the higher intake air flow rate, and the power required for the compression is increased even though the rotation speed remains the same. As discussed above, since the electric power consumption of the motor changes with the intake air temperature, the power converter and/or the induction generator of a high capacity, in which the low intake air temperature during the winter is taken into consideration, has hitherto been needed to use.

However, in the embodiment now under discussion, the completion timing of the primary warm-up is changed with the intake air temperature as hereinbefore described. More specifically, preparing a table, in which relations between the preset electric power value E for determining the completion timing of the primary warm-up and the intake air temperature are summarized, the preset electric power value E is determined so that the second peak P2 of the secondary warm-up, which is the maximum value of the required motor electric power, will not exceed over a predetermined value. In the embodiment now under discussion, as described hereinbefore, the lower the intake air temperature is, the lower the preset electric power value E is set.

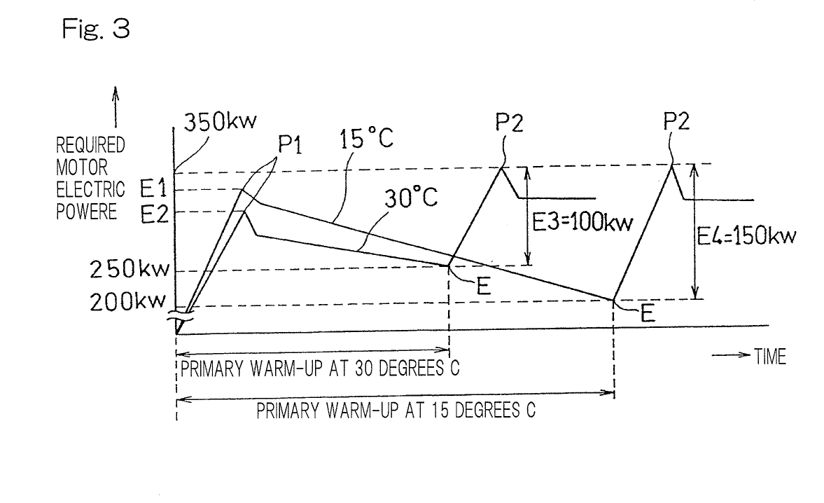

FIG. 3 illustrates a chart showing changes in required motor electric power when the intake air temperature is 15° C. and 30° C. As shown in the chart of FIG. 3, the preset electric power value E when the intake air temperature is 15° C. is set to 200 kW whereas the preset electric power value E when the intake air temperature is 30° C. is set to 250 kW.

As discussed above, in the gas turbine engine, as the intake air temperature is low, the intake air flow rate is increased and the compression drive power increases even though the rotation speed remains the same. Accordingly, the required motor electric powers E1 and E2 during a period from the starting to the attainment of the primary warm-up rotation speed and the required motor electric powers E3 and E4 during a period from the attainment of the primary warm-up rotation speed to the attainment of the secondary warm-up rotation speed are different in dependence on the intake air temperature. In view of this, the required motor electric powers E1 and E2 are the motor electric powers required during a period from the start to the attainment of the primary warm-up rotation speed when the intake air temperatures are 15° C. and 30° C., respectively. The required motor electric powers E3 and E4 are the motor electric powers required during a period from the primary warm-up rotation speed to the attainment of the secondary warm-up rotation speed when the intake air temperatures are 15° C. and 30° C., respectively.

The required motor electric power E3 during the period from the primary worm-up rotation speed to the attainment of the secondary warm-up rotation speed, when the intake air temperature is 15° C., is 150 kW, which is higher than 100 kW of the required electric power value E4 when the intake air temperature is 30° C. However, since the preset electric powers E, when the intake air temperatures are 15° C. and 30° C., are set to be 200 kW and 250 kW, respectively, the second peak P2, which is the maximum value of the required motor electric power, is the same value (350 kW). As discussed above, by rendering the preset electric power value E at the time of completion of the primary warm-up to be a value dependent on the intake air temperature, the maximum value of the required motor electric power can be rendered constant without being affected by the intake air temperature. As a result, the capacity of the power converter 11 and the capacity of the inverter motor IM can be further reduced.

Although in describing the foregoing embodiment, the catalytic combustor has been shown and described as the main combustor 2, the main combustor 2 need not necessarily be limited thereto. Also, the present invention can be equally applied to a lean fuel intake gas turbine engine of a type in which a low calorie gas is used as a fuel. Such low calorie gas may be a mixture of a coal mine methane (CMM) produced in coal mines with, for example, air and/or a ventilation air methane (VAM) exhausted from coal mines and may be used as a working gas having a concentration lower than the flammable limit concentration so that the mixture will not be ignited as a result of compression taking place in the compressor, which mixture is supplied into the engine to enable a combustible component contained therein. In particular, the present invention is effective to a system such as, for example, the lean fuel intake gas turbine engine which is not frequently boosted.

Also, in the foregoing embodiment, the number of warm-ups has been described as two stages, but it may be three or more stages. In addition, the use of the heat exchanger 6 shown in FIG. 1 may be dispensed with. Yet, the power converter 11 may not be necessarily required.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERAL

1 . . . Compressor

2 . . . Main combustor (Combustor)

3 . . . Turbine

4 . . . Rotating machine (Starter device)

6 . . . Heat exchanger

11 . . . Power converter

20 . . . Controller

GT . . . Gas turbine engine

IM . . . Starter device (Inverter motor)

G1 . . . Compressed gas

G2 . . . Combustion gas

G3 . . . Exhaust gas

E . . . Preset electric power value

What is claimed is:

1. A method of starting a gas turbine engine including a compressor to compress an intake air to thereby generate a compressed gas, a combustor to burn the compressed gas to thereby generate a high temperature, high pressure combustion gas, a turbine driven by the combustion gas, and a starter device in the form of a rotating machine which concurrently serves as an electric power generator driven by the turbine, the starter device including an inverter motor, which method comprises:
a primary warming step of warming up the gas turbine engine while a constant primary warm-up rotation speed is maintained by the inverter motor; and
a secondary warming step of warming up the gas turbine engine while a constant secondary warm-up rotation speed is maintained by further increasing the speed of the inverter motor.

2. The method of starting the gas turbine engine as claimed in claim 1, in which the primary warming step terminates when an electric power required by the inverter motor attains a preset electric power value, which is predetermined in correspondence with an intake air temperature.

3. The method of starting the gas turbine engine as claimed in claim 1, the gas turbine engine further comprising a heat exchanger to heat the compressed gas by means of the exhaust gas from the turbine,
wherein during the primary warming step and the secondary warming step, the gas turbine engine is warmed up by increasing the temperature of the compressed gas, which is increased by increasing the temperature of the exhaust gas.

4. The method of starting the gas turbine engine as claimed in claim 1, the gas turbine engine further comprising a power converter comprised of an inverter and a converter, the power converter being connected with the rotating machine, wherein
the rotating machine is driven as a starter device at the time of starting, and
during the primary warming step and the secondary warming step, the primary and secondary warm-up numbers of revolutions are respectively retained after the primary and secondary warm-up numbers of revolutions have been attained.

5. The method of starting the gas turbine engine as claimed in claim 1, wherein the gas turbine engine is a lean fuel intake gas turbine engine.

6. A gas turbine engine which comprises:
a compressor to compress an intake air to thereby generate a compressed gas;
a combustor to burn the compressed gas to thereby generate a high temperature, high pressure combustion gas;
a turbine driven by the combustion gas;
a starter device comprised of a rotating machine concurrently serving as an electric power generator driven by the turbine, the starter device including an inverter motor; and
a controller which is capable of performing such a control that a primary warm-up is effected to the gas turbine engine while a constant primary warm-up rotation speed is maintained by the inverter motor and a secondary warm-up is also effected to the gas turbine engine while a constant secondary warm-up rotation speed is maintained by further increasing the speed by means of the inverter motor.
